(19) United States
(12) Patent Application Publication
(10) Pub. No.: US 2026/0005765 A1
(43) Pub. Date: Jan. 1, 2026

(54) METHOD AND SYSTEM FOR MICROLENS-ARRAY-BASED STEERABLE OPTICAL TRANSCEIVER

(71) Applicant: RAM Photonics Industrial, LLC, Webster, NY (US)

(72) Inventors: John R. Marciante, Webster, NY (US); Stojan Radic, San Diego, CA (US)

(73) Assignee: RAM Photonics Industrial, LLC, Webster, NY (US)

(21) Appl. No.: 19/253,341

(22) Filed: Jun. 27, 2025

Related U.S. Application Data
(60) Provisional application No. 63/665,150, filed on Jun. 27, 2024.

(51) Int. Cl. H04B 10/118; G02B 6/26; H04B 10/50

(52) U.S. Cl. CPC H04B 10/118; G02B 6/262; H04B 10/503

(57) ABSTRACT

A laser communications terminal includes a laser, a receiver, and a photonic integrated circuit (PIC) optically coupled to the laser and the receiver. The laser communications terminal also includes a plurality of optical fibers. Each of the plurality of optical fibers is optically coupled to the PIC, and a microlens array. Each of the plurality of optical fibers is attached to the microlens array. The PIC can include a plurality of waveguides and a plurality of phase adjustment elements and each of the plurality of waveguides can be optically coupled to a corresponding phase adjustment element of the plurality of phase adjustment elements.

### CROSS-REFERENCES TO RELATED APPLICATIONS

This application claims priority to U.S. Provisional Patent Application No. 63/665,150, filed on Jun. 27, 2025, entitled “METHOD AND SYSTEM FOR MICROLENS-ARRAY-BASED STEERABLE OPTICAL TRANSCEIVER,” the disclosure of which is hereby incorporated by reference in its entirety for all purposes.

### BACKGROUND OF THE INVENTION

Laser communication between satellites has been used to communicate information with high data rates. NASA's Laser Communications Relay Demonstration (LCRD), launched in 2021, aims to demonstrate the long-term viability of two-way laser relay systems for both near-Earth and deep space missions. Some commercial satellite constellations are attempting to incorporate laser communication for inter-satellite links, creating space-based optical mesh networks.

Despite the progress made in the area of laser communication between satellites, there is a need in the art for improved methods and systems related to optical communications systems.

### SUMMARY OF THE INVENTION

The present disclosure relates generally to methods and systems related to optical systems suitable for optical communications. More particularly, embodiments of the present invention provide laser communication transceivers that can be used to send and receive optical communications signals between satellites. The disclosure is applicable to a variety of applications in lasers and optics, including other optical communication implementations.

Numerous benefits are achieved by way of the present disclosure over conventional techniques. For example, embodiments of the present invention enable high speed communications using low cost and low weight systems compared to conventional approaches. These and other embodiments of the disclosure, along with many of its advantages and features, are described in more detail in conjunction with the text below and corresponding figures.

### BRIEF DESCRIPTION OF THE DRAWINGS

FIG. 1 is a simplified schematic diagram illustrating a satellite constellation with laser transceivers according to an embodiment of the present invention.

FIG. 2 is a simplified schematic diagram illustrating bidirectional laser communication between two satellites according to an embodiment of the present invention.

FIG. 3 is a simplified schematic diagram illustrating components of a satellite-based, bidirectional laser communication system according to an embodiment of the present invention.

FIG. 4A is a simplified schematic diagram of a laser communication terminal according to an embodiment of the present invention.

FIG. 4B is a simplified schematic diagram illustrating components of a photonic integrated circuit according to an embodiment of the present invention.

FIG. 5 is a simplified schematic diagram of a laser communication terminal with a fill factor correction plate according to an embodiment of the present invention.

FIG. 6A is a simplified schematic diagram of a microlens array according to an embodiment of the present invention.

FIG. 6B is a simplified schematic diagram of aligning an optical fiber with a lenslet in a microlens array according to an embodiment of the present invention.

FIG. 7A is a simplified schematic diagram illustrating alignment of optical fibers and a microlens array according to an embodiment of the present invention.

FIG. 7B is a simplified schematic diagram illustrating alignment of optical fibers and a microlens array in a variable acceptance angle implementation according to an embodiment of the present invention.

FIG. 8 is a simplified schematic diagram of a laser communication terminal according to an alternative embodiment of the present invention.

FIG. 9 is a simplified flowchart illustrating a method of performing inter-satellite communications according to an embodiment of the present invention.

FIG.10A is a simplified cross-section diagram illustrating a silicon photonics substrate, an optical prism, and dual microlens arrays according to an embodiment of the present invention.

FIG. 10B is a simplified cross-section diagram illustrating a silicon photonics substrate, an optical prism, and dual microlens arrays according to an embodiment of the present invention.

FIG. 11 is a simplified cross-section diagram illustrating a silicon photonics substrate, a plurality of input optical fibers, and a spatially separated, fiberized microlens array according to an embodiment of the present invention.

FIG. 12 is a simplified plan view diagram illustrating a silicon photonics substrate, a plurality of input optical fibers, and a high density optical coupler according to an embodiment of the present invention.

### DETAILED DESCRIPTION OF THE INVENTION

The present disclosure relates generally to methods and systems related to optical systems suitable for optical communications. More particularly, embodiments of the present invention provide laser communication transceivers that can be used to send and receive optical communications signals between satellites. The disclosure is applicable to a variety of applications in lasers and optics, including other optical communication implementations.

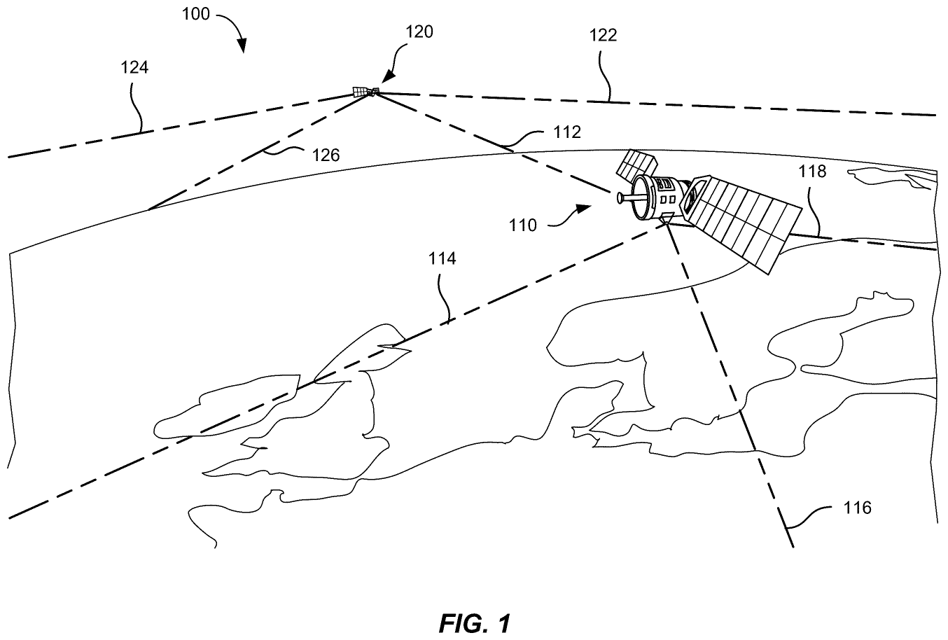

FIG. 1 is a simplified schematic diagram illustrating a satellite constellation with laser transceivers according to an embodiment of the present invention. As illustrated in the satellite constellation 100 shown in FIG. 1, two satellites (i.e., satellite 110 and satellite 120) are communicating with each other over one of four optical communications channels. In the illustrated embodiment, the mode of communications between satellites is laser-based communications. Although communications with ground stations (not shown) may be performed using radio frequency (RF) communications systems, the communications between satellites, also referred to in-layer communications or inter-satellite communications, is performed using optical communications systems, particularly laser communications systems. The inventors have determined that satellite-to-satellite optical communications significantly improve constellation performance in comparison with RF-based satellite-to-satellite communications since, in many cases, the vast majority of the data is in the layer, i.e., between satellites, and not between the satellites and the ground stations. Thus, RF-based communications between the satellites and the ground stations can be utilized in conjunction with laser-based, optical communications between satellites. Embodiments of the present invention provide laser communications terminals that are suitable for laser-based, optical communications between satellites.

In the embodiment illustrated in FIG. 1, four optical communications channels, i.e., first optical communications channel 112, second optical communications channel 114, third optical communications channel 116, and fourth optical communications channel 118 are illustrated in conjunction with satellite 110 and four optical communications channels, i.e., first optical communications channel 112, fifth optical communications channel 122, sixth optical communications channel 124, and seventh optical communications channel 126 are illustrated in conjunction with satellite 120. However, in other embodiments, three or fewer optical communications channels per satellite can be utilized while in alternative embodiments, more than four optical communications channels per satellite can be used. One of ordinary skill in the art would recognize many variations, modifications, and alternatives.

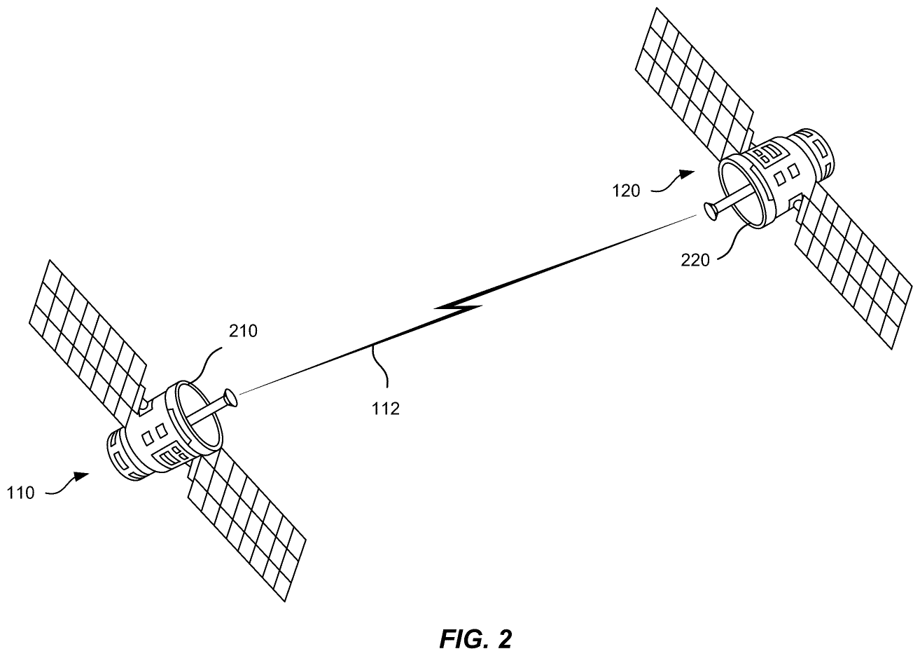

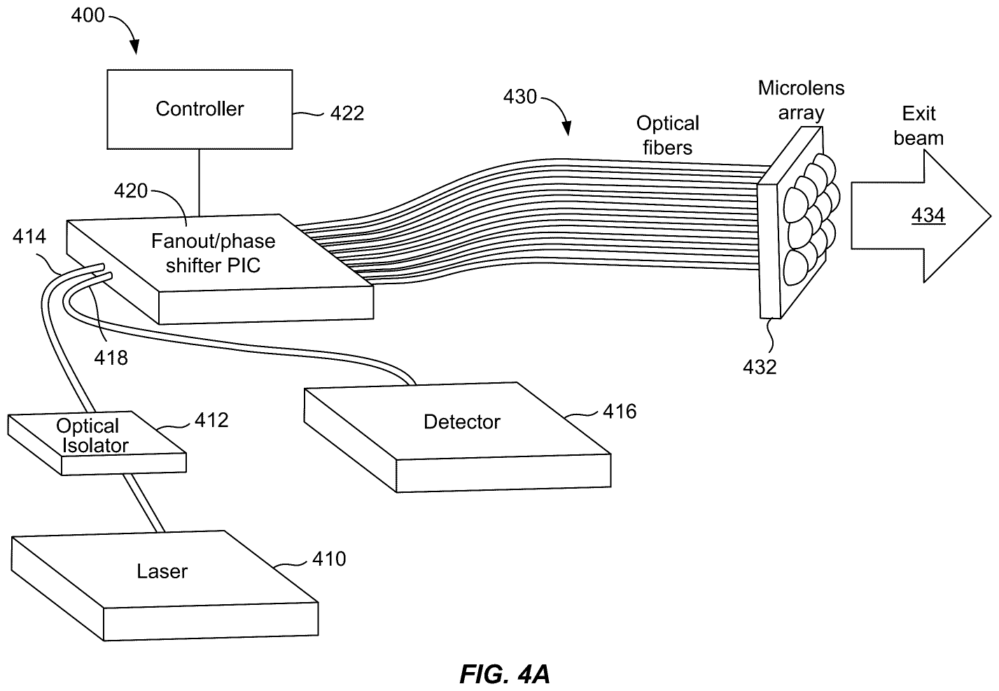

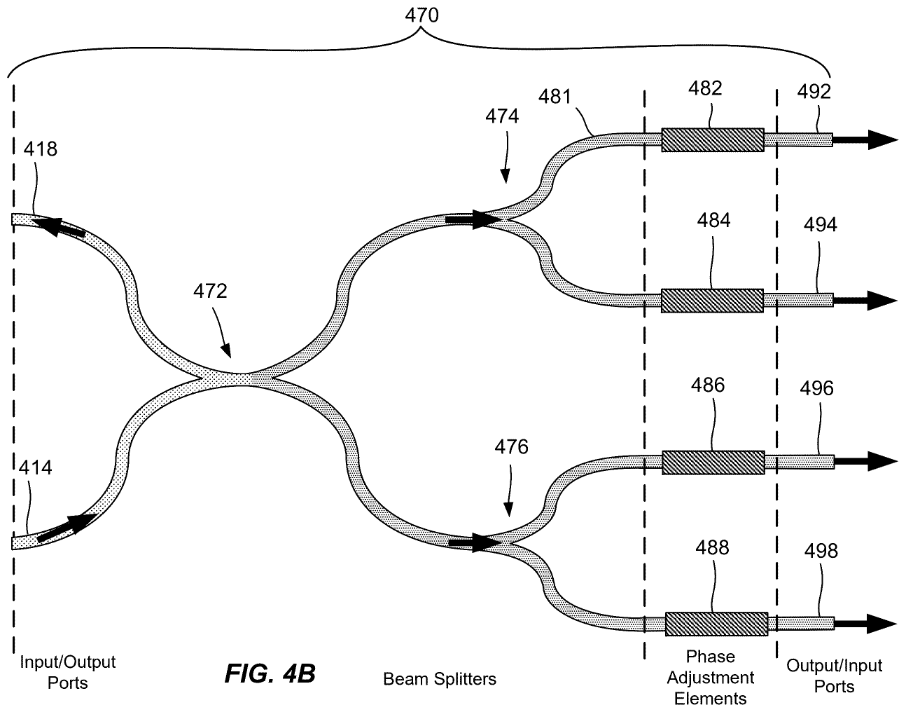

FIG. 2 is a simplified schematic diagram illustrating bidirectional laser communication between two satellites according to an embodiment of the present invention. In FIG. 2, satellite 110 is transmitting data to satellite 120 using laser communication terminal 210 and satellite 120 is receiving data from satellite 110 using laser communication terminal 220. Although unidirectional communications is illustrated in FIG. 2, this is merely for purposes of illustration and bidirectional communications are enabled by the various embodiments discussed herein. In particular, as discussed more fully in relation to FIG. 4A, the laser communications terminals discussed herein provide for bidirectional communications using a photonic integrated circuit including beam splitters and phase adjustment elements and a plurality of optical fibers bonded to a microlens array such that light can be transmitted through the optical fibers and the microlens array as well as being received by the microlens array and the optical fibers.

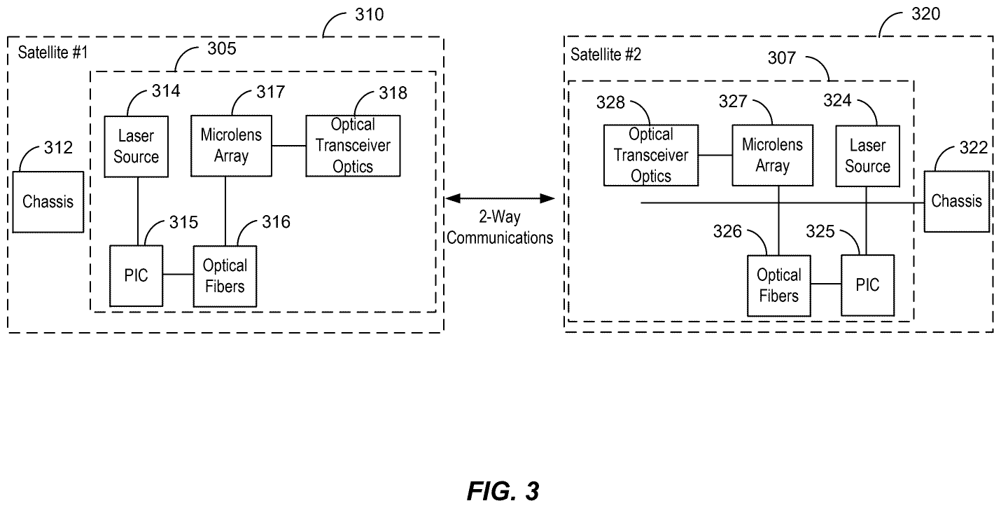

FIG. 3 is a simplified schematic diagram illustrating components of a satellite-based, bidirectional laser communication system according to an embodiment of the present invention. Referring to FIG. 3, two satellites are illustrated, i.e., satellite 310 and satellite 320. Satellite 310 and satellite 320 can be satellite 110 and satellite 120 illustrated in FIGS. 1 and 2. Each satellite can be identical or different depending on the particular application. In order to implement bidirectional communication between satellite 310 and satellite 320 and referring to satellite 310, each satellite includes a laser communication terminal 305 mounted to a chassis 312. Laser communication terminal 305 includes a laser source 314, for example, a single mode semiconductor laser outputting, for example, 100 mW, 500 mW, 1 W, 2 W, 5 W, or the like. The power can be adjustable in some embodiments. Laser communication terminal 305 also includes a photonic integrated circuit (PIC) 315 and an optical fiber bundle including a plurality of optical fibers 316. The light from laser source 314 is input into PIC 315, which includes a plurality of waveguides, beam splitters, and phase adjustment elements. As an example, a single input port could receive the light from laser source 314 and utilize a fanout network to split the single input into a large number of laser signals, for example, 2,000 laser signals, each propagating in a separate waveguide of the PIC. Each of these waveguides can be optically coupled to a phase adjustment element that can adjust the phase of the laser signal propagating in the corresponding waveguide. After phase adjustment, the phase-adjusted laser signal can propagate in another waveguide that forms an output port of the PIC. In this example, with the light from the laser source split into 2,000 laser signals, 2,000 output waveguides coupled to 2,000 output ports would be coupled to 2,000 optical fibers making up the plurality of optical fibers 316.

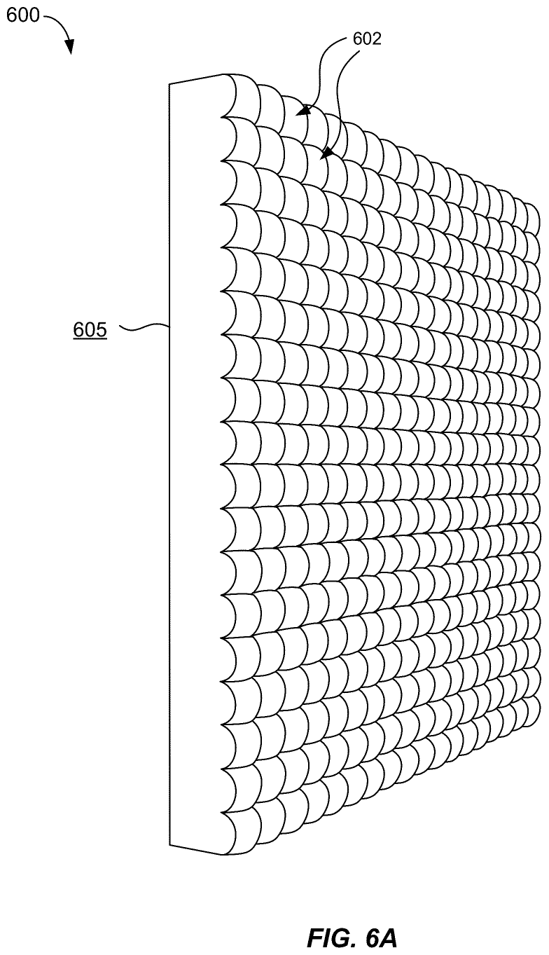

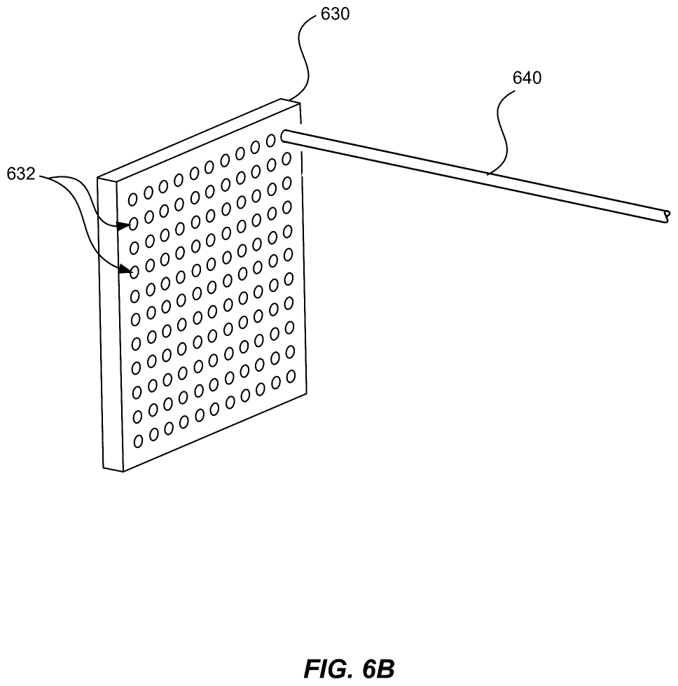

The plurality of optical fibers 316 are bonded, e.g., laser welded, to a microlens array 317 as discussed more fully in relation to FIGS. 6A and 6B. An optional set of optical transceiver optics 318 is optically coupled to the microlens array 317. Like satellite 310, satellite 320 includes a laser communication terminal 307 mounted to a chassis 322. Laser communication terminal 307 includes a laser source 324, a PIC 325, an optical fiber bundle including a plurality of optical fibers 326, a microlens array 327, and an optional set of optical transceiver optics 328.

As discussed more fully herein, optical signals generated at satellite 310 can be transmitted to satellite 320 and optical signals generated at satellite 320 can be transmitted to satellite 310 in order to implement bidirectional communications. Thus, although the discussion above is directed to transmission of signals from satellite 310 and reception of signals at satellite 320, it will be appreciated that this discussion is merely exemplary and bidirectional communications are enabled by embodiments of the present invention.

FIG. 4A is a simplified schematic diagram of a laser communication terminal 400 according to an embodiment of the present invention. As illustrated in FIG. 4A, laser communication terminal 400 includes a laser source 410 used as a transmitter and a detector 416 used as a receiver. Thus, laser communication terminal 400 implements an optical transceiver. Both the laser source 410 used as a transmitter and the detector 416 used as a receiver are optically coupled to photonic integrated circuit (PIC) 420, which utilizes optical splitters and phase control implemented through phase adjustment elements to divide the signal received from the laser transmitter and provide output signals to the plurality of optical fibers 430 with control of the relative phases of each of the signals output by the PIC 420 and propagating in the plurality of optical fibers 430 during transmit operations. Input light from laser source 410 is received in transmit mode at input port 414 and output light produced by the PIC in receive mode is output at output port 418. An optical isolator 412 is utilized between laser source 410 and input port 414 of PIC 420 in order to prevent optical feedback from PIC 420 from adversely impacting the performance of laser source 410. Additional description related to waveguides, beam splitters/beam combiners, and phase adjustment elements is provided in relation to FIG. 4B below.

During transmit operations, as discussed above in relation to FIG. 3, the input signal generated using laser source 410 is split into a plurality of transmit signals using waveguides and beam splitters implemented in PIC 420. Each transmit signal propagating in a waveguide in the PIC is coupled into a corresponding phase adjustment element operating under the control of controller 422. The phase adjustment elements enable control of the phase of each output provided by the PIC and, as a result, generation of a coherent array of outputs from microlens array 432 represented by exit beam 434.

During receive operations, the PIC 420 utilizes optical combiners and/or phase control to combine signals received from the plurality of optical fibers into a detection signal provided to the detector 416, also referred to as a receiver. As will be evident to one of skill in the art, the beam splitters used to generate multiple optical signals from a single input signal will work in reverse to combine multiple optical signals into a single output signal that can be delivered to the detector 416.

During transmit operation, as discussed above, the transmitted optical signals are phase-adjusted in order to enable spatial coherence as well as to provide a specific shape for the outgoing optical beam front represented by exit beam 434. In addition to phase control corresponding to spatial coherence between the individual signals output from the microlenses of the microlens array, the phase adjustment elements can be utilized to steer the exit beam 434 by introducing a tilt in the phase of exit beam 434. Thus, beam steering is implemented in a solid-state structure by embodiments of the present invention without the use of a moveable telescope, which are generally large and heavy. Lacking any moving parts, embodiments of the present invention provide significant benefits not available using conventional motion-based telescopes.

The PIC provides an optical fanout function utilizing waveguides and phase shifters. The fanout network of the PIC is illustrated with a single input fiber (i.e., from the laser transmitter) and a plurality of output fibers (i.e., interfaced or attached to the microlens array). As an example, in an embodiment, the plurality of output fibers are laser welded to the microlens array to avoid the use of epoxy in the optical path that can affect the optical path. In some examples, the number of output fibers is on the order of thousands, e.g., ˜4,000), but other embodiments utilize a different number of output fibers. It should be noted that the large aperture associated with the microlens array, in comparison to the aperture of a semiconductor laser, provides a low divergence over the distances between satellites and, as a result, a small far field pattern. One of ordinary skill in the art would recognize many variations, modifications, and alternatives.

FIG. 4B is a simplified schematic diagram illustrating components of a photonic integrated circuit according to an embodiment of the present invention. As illustrated in FIG.

4B, the PIC 470 receives an optical signal from laser source 410 at input port 414. PIC 470 includes beam splitters 472, 474, and 476 that split the optical signal into four optical signals in this embodiment. As will be evident to one of skill in the art, when PIC 470 receives return light, the beam splitters will operate as optical combiners, combining multiple optical signals into a single signal. In this receive mode of operation, a splitter coupled to a detector can be used to detect this return light. One of ordinary skill in the art would recognize many variations, modifications, and alternatives.

PIC 470 also includes phase adjustment elements 482, 484, 486, and 488, which can be used to adjust the phase of the light propagating in the waveguide 481 corresponding to each phase adjustment element. As a result, coherent light provided by laser source 410 can be split into multiple optical signals, which can be referred to as input signals with respect to the phase adjustment elements, all of which can be spatially coherent when output from output/input ports 492, 494, 496, and 498 since each of the phase adjustment elements can be used to produce phase-adjusted input signals suitable for output by the PIC 470. As discussed above, although the operation of PIC 470 in transmit mode is illustrated in FIG. 4B, it will be appreciated that PIC 470 can also be operated in receive mode with optical signals received at output/input ports 492-498, phase adjusted using phase adjustment elements 482-488, and combined using beam splitters 476, 474, and 472. In receive mode, the optical signals will be output at output port 418.

Intersymbol interference (ISI) can occur due to distortion of the waveform of the incoming beam, distortion of the angular spectrum of the incoming beam received on the array, and/or the Doppler effect, which has a strong angular dependence. In each case, having an input that varies across the receiving array leads to different time delays in the received data for each microlens element. When combining these signals, either in an array of detectors or a single detector subsequently propagated back through the silicon photonics chip, the time delay between arms will result in a loss of synchronization in the signal from each arm. When the bit slots of the various data streams do not overlap, the effect is to have energy from one slot spilling over into the neighboring slot, commonly known as intersymbol interference. According to embodiments of the present invention, the phase shifters in the PIC can be used to modify optical path length in each arm, i.e, each waveguide of the PIC, thus mitigating the effect of intersymbol interference.

In embodiments of the present invention in which a single detector is used to receive the signal as illustrated in FIG. 4A, the light from each arm of the fiber array will preferably add coherently and constructively through a series of combiners in order to avoid loss of the received photon field. A plane wave incident on the array will produce waveforms in each optical fiber with the same phase, allowing all of the incident power to be received constructively, without loss at the detector. Wavefront distortion present in the incident beam that is received at the array will result in a different phase in each fiber port, leading to only partial constructive or even complete destructive interreference at the combiners, which, in turn, will result in optical signal loss at the detector. According to embodiments of the present invention, the phase adjusters in each channel can be used to align the phases in each arm to mitigate loss at the detector that would otherwise occur due to aberrations on the impinging beam.

Referring to FIG. 4A, the bonding of the optical fibers 430 to the output ports of the PIC 420 at one end and to the microlens array 432 at the other end enables a monolithic structure free of epoxies. In some embodiments, the optical fibers are attached, for example, optically bonded, fused, or welded (e.g., laser welded) onto PIC 420 and microlens array 432, thereby providing reliability and alignment accuracy not provided by some other approaches. In particular, the entire optical path, from the laser to the input ports of the PIC, internally inside the PIC to the output ports of the PIC, through the optical fibers, and to the microlens array can be monolithic, the entire system, from the laser to the microlens array can be only glass, semiconductor, or other suitable materials.

A wide variety of optical fibers can be utilized in the systems discussed herein, including single mode fibers such as SMF-28 available from Corning, Inc. of Corning, NY. In embodiments in which single mode fibers are utilized, the laser and the output ports of the PIC can be mode matched to the single mode optical fibers although this is not required and non-mode matched implementations are included within the scope of the present invention. A variety of input coupling elements can be utilized to input light from the laser to the PIC, including direct bonding, grating couplers, also referred to as diffraction grating couplers, holographic optical elements, 45° etched mirrors or the like. Grating couplers are merely one example of input coupling elements that can be utilized to couple light into optical waveguides present in the PIC and the discussion of grating couplers as an example does not preclude the use of other forms of input coupling elements in various embodiments of the present invention.

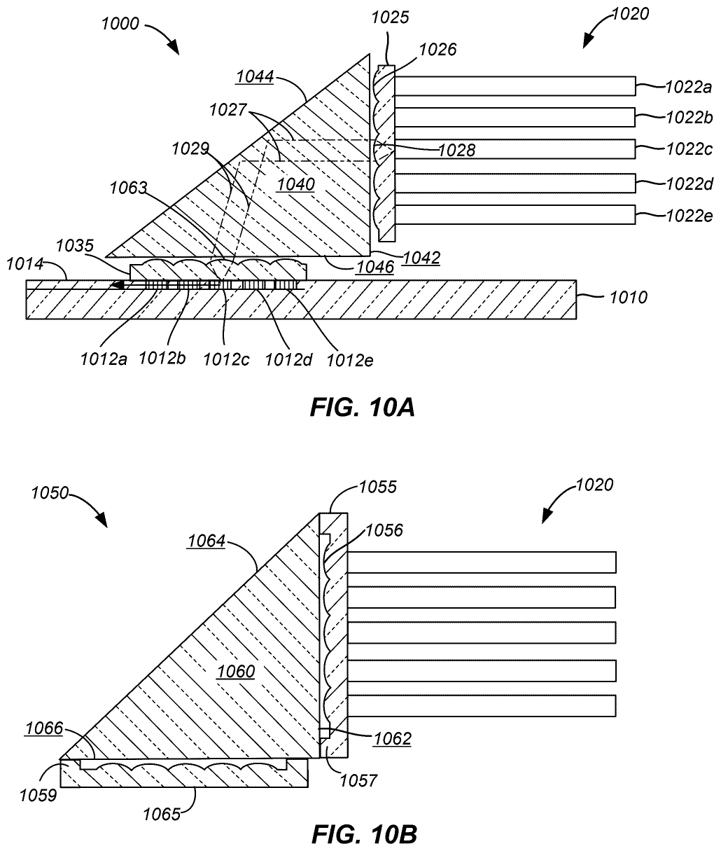

Embodiments of the present invention can utilize one of several structures to bond the optical fibers 430 to the output ports of the PIC 420. Exemplary structures are discussed in relation to FIGS. 10A-12 and U.S. patent application Ser. No. 19/076,838, the disclosure of which is hereby incorporated by reference in its entirety for all purposes.

Referring to FIG. 10A, system 1000 includes a silicon photonics substrate 1010 that includes input coupling elements 1012a, 1012b, 1012c, 1012d, and 1012e as well as optical waveguides represented by optical waveguide 1014. Other elements, including both active and passive devices, can be provided on the silicon photonics substrate 1010 as will be evident to one of skill in the art.

As shown in FIG. 10A, a plurality of optical fibers 1020 are utilized to provide multiple optical inputs, illustrated by optical fibers 1022a, 1022b, 1022c, 1022d, and 1022e. Although five optical fibers are illustrated in FIG. 10A, it will be appreciated that embodiments of the present invention will generally utilize a two-dimensional array of optical fibers arrayed in both the plane of the figure and into the plane of the figure. The optical fibers are attached, for example, optically bonded, fused, or welded (e.g., laser welded) onto a microlens array (MLA) 1025 and the component formed by the optical fibers and the MLA can be referred to as a fiberized MLA. As shown in FIG. 10A, MLA 1025 may include multiple lenslets 1026. Each lenslet 1026 may be referred to as a microlens. Each of the lenslets 1026 may serve to collimate light emitted by a corresponding optical fiber.

The optical coupler 1040 utilized in the embodiment illustrated in FIG. 10A is a prism with three planar surfaces: input surface 1042, hypotenuse surface 1044, and output surface 1046. A second MLA 1065 is disposed between optical coupler 1040 and silicon photonics substrate 1010 and focuses light output from optical coupler 1040 onto input coupling elements as described more fully herein. The space between output surface 1046 and silicon photonics substrate 1010 can be set at a predetermined distance using an appropriate spacer. One of ordinary skill in the art would recognize many variations, modifications, and alternatives.

Referring to FIG. 10A, the optical signal emitted by optical fiber 1022c propagates through microlens 1028 and is collimated as represented by light rays 1027. After propagation to hypotenuse surface 1044, light rays 1027 are reflected via TIR to produce light rays 1029. Light rays 1029 are focused by microlens 1063 and converge as they propagate toward input coupling element 1012c. Thus, in this embodiment, one-to-one imaging is performed, focusing light emitted by optical fiber 1022c onto input coupling element 1012c. In this way, the optical mode propagating in the optical fiber is matched to the optical mode incoupled by the input coupling element and, in turn, the optical waveguide.

In some embodiments, the microlenses in MLA 1025 may be identical to each other and the microlenses in MLA 1035 may be identical to each other. In other embodiments, each of the microlenses in MLA 1025 and/or each of the microlenses in MLA 1035 can have unique optical parameters, including size, focal length, asphericity, and the like. One of ordinary skill in the art would recognize many variations, modifications, and alternatives.

FIG. 10B is a simplified cross-section diagram illustrating a silicon photonics substrate,

an optical prism, and dual microlens arrays according to an embodiment of the present invention. The system illustrated in FIG. 10B shares common elements with the system illustrated in FIG. 10A and the description provided in relation to the system illustrated FIG. 10A is applicable to the system illustrated in FIG. 10B as appropriate.

Referring to FIG. 10B, system 1050 includes a plurality of optical fibers 1020 that are utilized to provide multiple optical inputs. The optical fibers are attached to MLA 1055 and the component formed by the optical fibers and the MLA can be referred to as a fiberized MLA. As shown in FIG. 10B, MLA 1055 may include multiple lenslets 1056, also referred to as microlenses, and MLA 1055 can share common characteristics with MLA 1025 illustrated in FIG. 10A. System 1050 can be utilized in conjunction with a silicon photonics substrate (not shown) as discussed more fully herein.

The optical coupler 1060 utilized in the embodiment illustrated in FIG. 10B is a prism with three planar surfaces. Collimated light is incident through input surface 1062, reflects off of hypotenuse surface 1064 by TIR, and is output through output surface 1066. In order to provide a predetermined distance between MLA 1055 and input surface 1062, spacers 1057 are positioned on the periphery of MLA 1055. Spacers 1057 can be butt coupled to optical coupler 1060, laser welded to optical coupler 1060, or the like. In some embodiments, spacers 1057 are part of MLA 1055, whereas in other embodiments, spacers 1057 are provided as a separate component, for example, an annular structure with a rectangular shape in plan view. Additionally, in order to provide a predetermined distance between second MLA 1065 and output surface 1066, spacers 1059 are positioned on the periphery of second MLA 1065. Spacers 1059 can be butt coupled to optical coupler 1060, laser welded to optical coupler 1060, or the like. In some embodiments, spacers 1059 are part of second MLA 1065, whereas in other embodiments, spacers 1059 are provided as a separate component, for example, an annular structure with a rectangular shape in plan view.

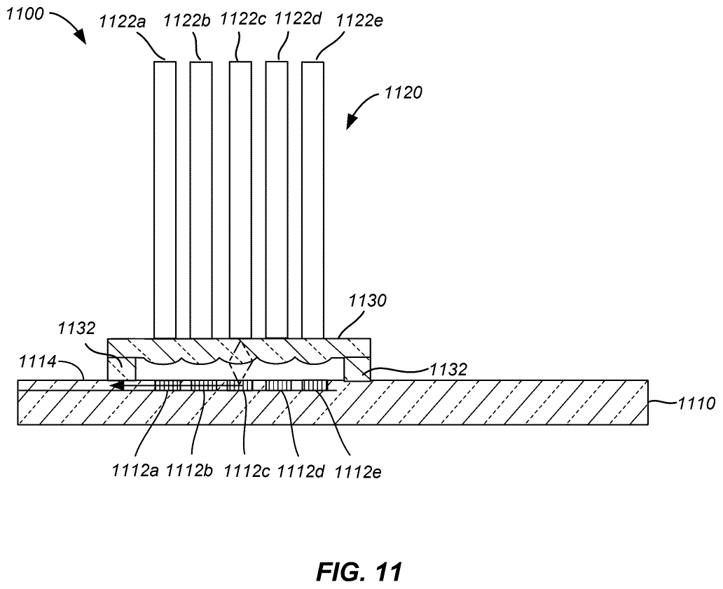

FIG. 11 is a simplified cross-section diagram illustrating a silicon photonics substrate, a plurality of input optical fibers, and a spatially separated, fiberized microlens array according to an embodiment of the present invention. Referring to FIG. 11, system 1100 includes a silicon photonics substrate 1110 that includes input coupling elements 1112a, 1112b, 1112c, 1112d, and 1112e as well as optical waveguides represented by optical waveguide 1114.

As shown in FIG. 11, a plurality of optical fibers 1120 are utilized to provide multiple optical inputs, illustrated by optical fibers 1122a, 1122b, 1122c, 1122d, and 1122e. The optical fibers will generally be a two-dimensional array of optical fibers, arrayed in both the plane of the figure and into the plane of the figure. Each of the optical fibers is attached, for example, optically bonded, fused, or welded (e.g., laser welded) onto MLA 1130, which is separated from silicon photonics substrate 1110 by a predetermined distance using spacers 1132 that are positioned on the periphery of MLA 1130. Spacers 1132 can be butt coupled to MLA 1130, laser welded to MLA 1130, or the like. In some embodiments, spacers 1132 are part of MLA 1130, whereas in other embodiments, spacers 1132 are provided as a separate component, for example, an annular structure with a rectangular shape in plan view. In some embodiments, spacers 1132 can be fabricated during fabrication of MLA 1130, for example, by leaving a boundary around the microlenses after etching of the microlenses. Although one-to-one imaging is illustrated in FIG. 11, this is not required and other imaging formats can be utilized.

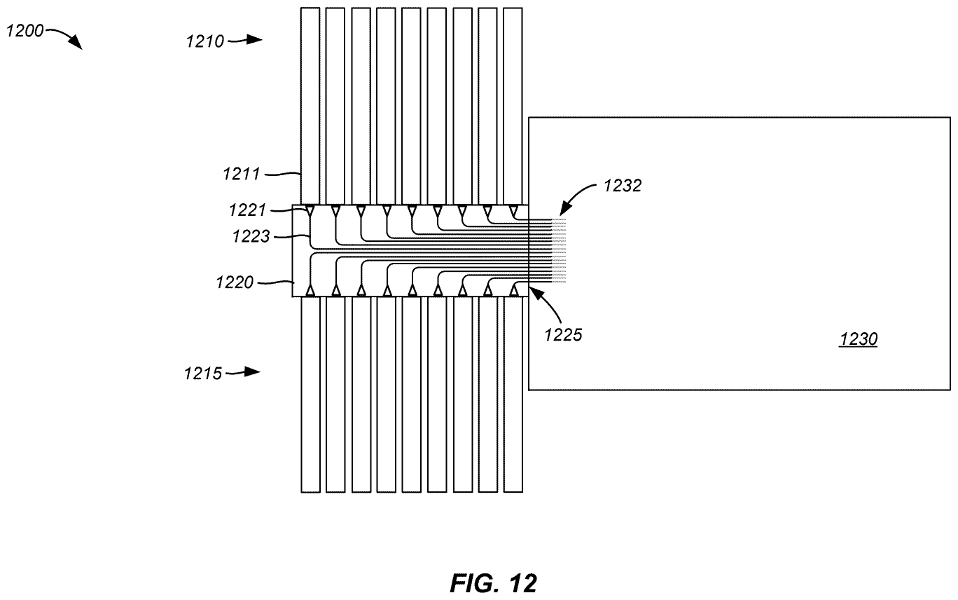

FIG. 12 is a simplified plan view diagram illustrating a silicon photonics substrate, a plurality of input optical fibers, and a high density optical coupler according to an embodiment of the present invention. As illustrated in FIG. 12, system 1200 includes two sets of input optical fibers, first set of fibers 1210 and second set of fibers 1215, each of which are optically coupled to high density optical coupler 1220. In some embodiments, each of the optical fibers in first set of fibers 1210 and second set of fibers 1215 is laser welded at a predetermined location on high density optical coupler 1220.

High density optical coupler 1220 can be a glass optical element or asilicon optical element depending on the particular application. A plurality of mode field adapters (MFAs) are integrated into high density optical coupler 1220. As a result, input light transmitted through an optical fiber, for example, input optical fiber 1211, is input in mode field adapter (MFA) 1221 and propagates in waveguide 1223. Similarly, light from other input optical fibers is input into other MFAs prior to propagation in other waveguides. As shown in FIG. 12, the waveguides present in high density optical coupler 1220 can be designed to provide an array of waveguides at output surface 1225 of high density optical coupler 1220. The array of waveguides at output surface 1225 of high density optical coupler 1220 are optical coupled to a corresponding array of waveguides 1232 present on silicon photonics device 1230.

Thus, in the embodiment illustrated in FIG. 12, edge coupling into silicon photonics device 1230 is utilized rather than surface coupling as discussed in other embodiments. Since the optical fiber mode is converted to a waveguide mode off of the silicon photonics device, the real estate of the silicon photonics device can be utilized more efficiently as appropriate to the small size of silicon photonics device waveguides. It should be noted that scaling of system 1200 is generally only limited by the silicon photonics device waveguide density, not the diameter of the input optical fibers. One of ordinary skill in the art would recognize many variations, modifications, and alternatives.

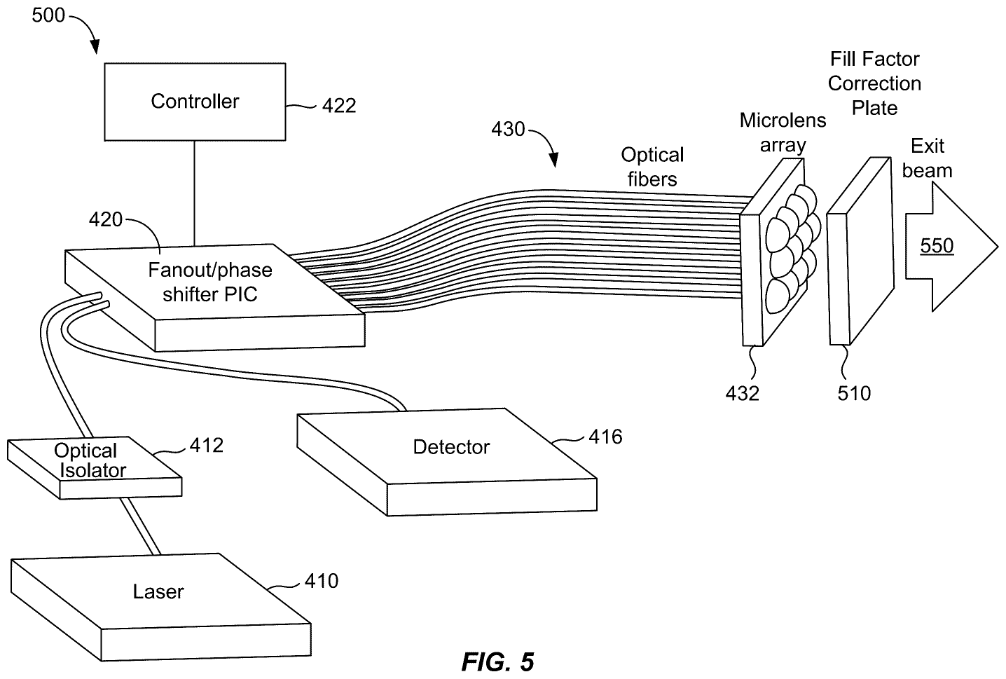

FIG. 5 is a simplified schematic diagram of a laser communication terminal with a fill factor correction plate according to an embodiment of the present invention. The laser communication terminal 500 illustrated in FIG. 5 shares common elements with the laser communication terminal 400 illustrated in FIG. 4A and the description provided in relation to FIG. 4A is applicable to FIG. 5 as appropriate. In FIG. 5, laser communication terminal 500 incorporates a fill-factor correction plate 510 that is positioned optically downstream of the microlens array, i.e., to the right of the microlens array in FIG. 5. Fill-factor correction plate 510 improves the beam quality in the far field of the exit beam 550 emitted by the laser communications terminal by converting multiple beamlets into a single beam on transmission and enhances coupling of the received beam into the microlens array when laser communications terminal 500 is operating in the receive mode by converting a single received beam into a plurality of beamlets each directed to one of the microlens elements.

FIG. 6A is a simplified schematic diagram of a microlens array 600 according to an embodiment of the present invention. As shown, the microlens array 600 may include multiple lenslets 602, also referred to as a microlens or a microlens element. A microlens element may be a small lens, generally with a diameter less than a millimeter and as small as 10 um. Each of the lenslets 602 may be a single microlens with one planar surface and one convex (e.g., spherical) surface to refract the light. In some cases, the lenslets 602 may be or include several layers of optical material to achieve desired optical properties. In some embodiments, the microlens array 600 may be formed by a one-dimensional or two-dimensional array of the lenslets 602 on a supporting substrate. The lenslets 602 may serve to focus and concentrate light from one or more optical fibers.

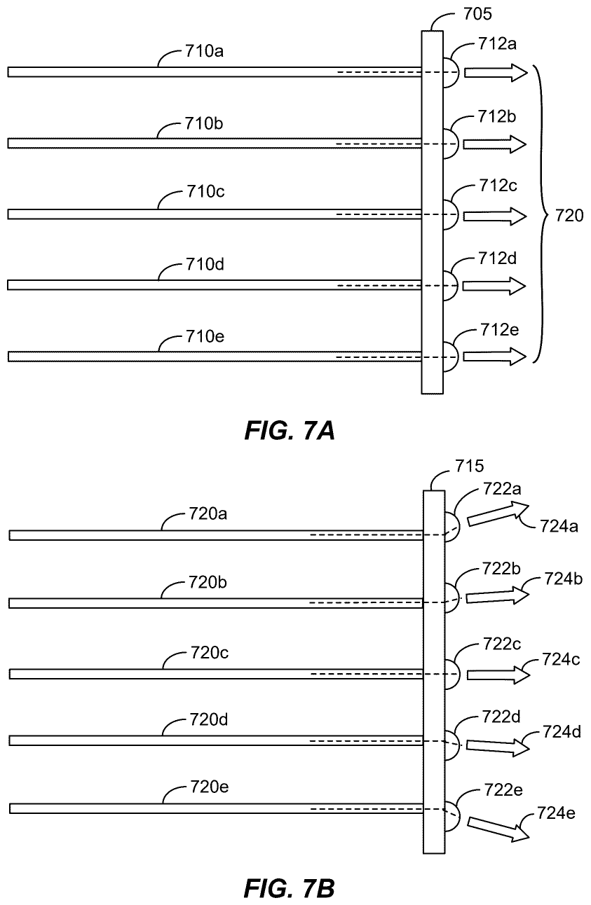

As discussed more fully in relation to FIGS. 7A and 7B, a plurality of optical fibers can be bonded, e.g., laser welded to the microlens array 600, for example, at a microlens interface 605. During bonding, a variety of techniques can be utilized to align the optical fibers to the lenslets of the microlens array.

FIG. 6B is a simplified schematic diagram of aligning an optical fiber with a lenslet in a microlens array according to an embodiment of the present invention. As illustrated in FIG. 6B, an orifice plate 630 having multiple orifices 632 is positioned adjacent the microlens array illustrated in FIG. 6A. In some embodiments, a microlens array may be part of the orifice plate 630. In other embodiments, the orifice plate 630 may be aligned with a microlens array such that each of the orifices 632 align with a lenslet of the microlens array. The spacing between the orifices 632 of the orifice plate 630 can match the spacing between the lenslets 602 of the microlens array 600. In an example, the orifices 632 may be manufactured with lithography techniques.

To align the optical fiber 640 with a lenslet, the optical fiber 640 may be inserted into one of the orifices 632. Since the orifice is aligned with a lenslet, inserting the optical fiber 640 into one of the orifices 632 is used to align the optical fiber 640 with the lenslet. Subsequently, laser welding can be utilized to join the optical fiber 640 with the corresponding lenset.

Although some embodiments can utilize an orifice plate as illustrated in FIG. 6B, this is not required by the present invention and other bonding techniques can be utilized as appropriate to the particular application.

FIG. 7A is a simplified schematic diagram illustrating alignment and laser welding of optical fibers and a microlens array according to an embodiment of the present invention. Referring to FIG. 7A, multiple optical fibers, 710a-710e are aligned with lenslets 712a-712e and laser welded to microlens array 705. Although only five optical fibers and five lenslets are illustrated in FIG. 7A, it will be appreciated that this number is merely exemplary and other numbers of optical fibers and lenslets can be utilized by embodiments of the present invention.

In the illustrated embodiment, each of the lenslets 712a-712e of the microlens array 705 is aligned with one of the multiple optical fibers 710a-710e. For example, the lenslet 712a may be aligned with the optical fiber 710a, the lenslet 712b may be aligned with the optical fiber 710b, the lenslet 712c may be aligned with the optical fiber 710c, the lenslet 712d may be aligned with the optical fiber 710d, and the lenslet 712e may be aligned with the optical fiber 710e.

In some embodiments, a golden fiber may be used for alignment of each of the lenslets 712a-712e. For example, the golden optical fiber may be used to align each of the lenslets 712a-712e using a microlens array alignment system. Once each of the lenslets 712a-712e are in an alignment position, based on the alignment threshold, then the golden optical fiber may be removed from the system and replaced with one of the multiple optical fibers 710a-710e for each of the respective lenslets 712a-712e. Then the optical fiber may be secured to the microlens array, for example, by laser welding. Once an optical fiber is secured to the microlens array, the microlens array may be repositioned and the golden optical fiber may be used to position the next microlens. Thus, the process may continue for each of the multiple optical fibers 710a-710e. It should be understood that any number of multiple optical fibers 710a-710e and any number of lenslets 712a-712e may be aligned and/or secured using the systems and techniques used herein.

As illustrated in FIG. 7A, each of the optical fibers is aligned with the corresponding lenset such that the output beam 720 including collimated outputs from each of the lenslets are parallel to each other. In other embodiments, as illustrated in FIG. 7B, the collimated outputs are characterized by finite angle differences between each other, which enables an increase in the acceptance angle of the received beam at the cost of optical efficiency for light received on-axis. As described in relation to FIG. 7B, the microlens array includes a central region and a peripheral region surrounding the central region. The optical fibers are joined to corresponding microlens elements in the peripheral region at positions farther from the center of the microlens array than corresponding positions of the corresponding microlens elements in the central region.

FIG. 7B is a simplified schematic diagram illustrating alignment of optical fibers and a microlens array in a variable acceptance angle implementation according to an embodiment of the present invention. As illustrated in FIG. 7B, multiple optical fibers, 720a-720e are aligned with lenslets 722a-722e and laser welded to microlens array 715. In contrast with the embodiment illustrated in FIG. 7A, only the lenslet 722c is aligned with the optical fiber 720c.

The other four lenslets of the microlens array are intentionally mis-aligned with respect to the corresponding optical fiber.

In the embodiment illustrated in FIG. 7B, the optical fibers near the periphery of the microlens array are positioned closer to the center of the microlens array than the corresponding microlens element to which the optical fiber is interfaced. As illustrated in FIG. 7B, the optical fibers (i.e., optical fibers 720a and 720b) near the top of the microlens array 715 are interfaced to the corresponding microlens element (i.e., lenslet 722a and 722b) at a height below the height of the microlens element. Similarly, the optical fibers (i.e., optical fibers 720d and 720e) near the bottom of the microlens array 715 are interfaced or attached (e.g., using laser welding) to the corresponding microlens element (i.e., lenset 722d and 722e) at a height above the height of the microlens element. As a result, light 724a emitted from the top lenset 722a propagates at an upward angle and light 724e emitted from the bottom lenset 722e propagates at a downward angle. Similarly, light 724b emitted from the second lenset 722b propagates at an upward angle and light 724d emitted from the fourth lenset 722d propagates at a downward angle. Light 724c emitted from the central lenset 722c propagates without angular deviation.

Thus, the acceptance angle of a received beam is increased at the cost of optical efficiency for light received on-axis. Thus, embodiments of the present invention provide systems in which the acceptance angle of the microlens system can be predetermined and adjustable based on the offset between the centers of the optical fibers and the corresponding microlens element to which an optical fiber is attached.

Although five optical fibers are illustrated in FIGS. 7A and 7B, it will be appreciated that embodiments of the present invention will generally utilize a two-dimensional array of optical fibers arrayed in both the plane of the figure and into the plane of the figure. The optical fibers are attached, for example, optically bonded, fused, or welded (e.g., laser welded) onto a microlens array and the component formed by the optical fibers and the microlens array can be referred to as a fiberized microlens array. In these two-dimensional implementations, the microlens array can be described as having a central region and a peripheral region surrounding the central region. The optical fibers can be joined to corresponding microlens elements in the peripheral region of the microlens array at positions farther from the center of the microlens array than corresponding positions of the corresponding microlens elements in the central region. One of ordinary skill in the art would recognize many variations, modifications, and alternatives.

In some embodiments, the microlenses in the microlens array may be identical to each other. In other embodiments, each of the microlenses in the microlens array can have unique optical parameters, including size, focal length, asphericity, and the like. One of ordinary skill in the art would recognize many variations, modifications, and alternatives.

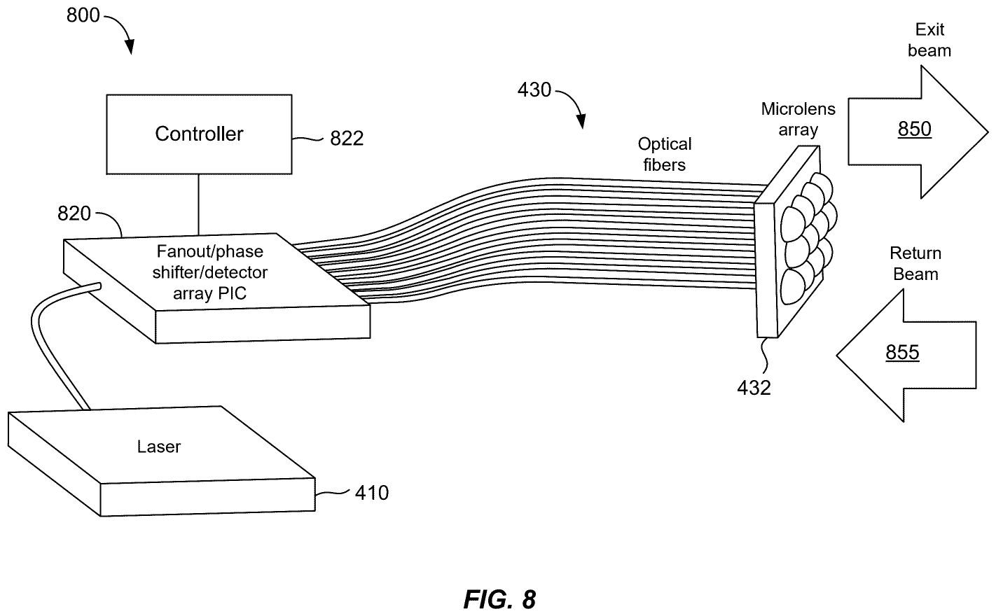

FIG. 8 is a simplified schematic diagram of a laser communication terminal according to an alternative embodiment of the present invention. The laser communication terminal 800 illustrated in FIG. 8 shares common elements with the laser communication terminal 400 illustrated in FIG. 4A and the description provided in relation to FIG. 4A is applicable to FIG. 8 as appropriate. In FIG. 8, laser communication terminal 800 incorporates a PIC 820 and controller 822 that includes an integrated array of detectors. Thus, in the embodiment illustrated in FIG. 8, the transmitted light (i.e., exit beam 850) is output by laser communication terminal 800 and the return light (i.e., return beam 855) coming to the PIC 820 from the microlens array 432 is received at an array of detectors (not shown) on the PIC 820 instead of being transmitted back through the fanout array to a single on-chip or off-chip detector, for example, detector 416 illustrated in FIG. 4A.

Additionally, in other embodiments, the laser source 410 can be integrated inside the PIC, enabling the PIC to implement both light generation for transmission of optical signals and/or light detection for receipt of optical signals. One of ordinary skill in the art would recognize many variations, modifications, and alternatives.

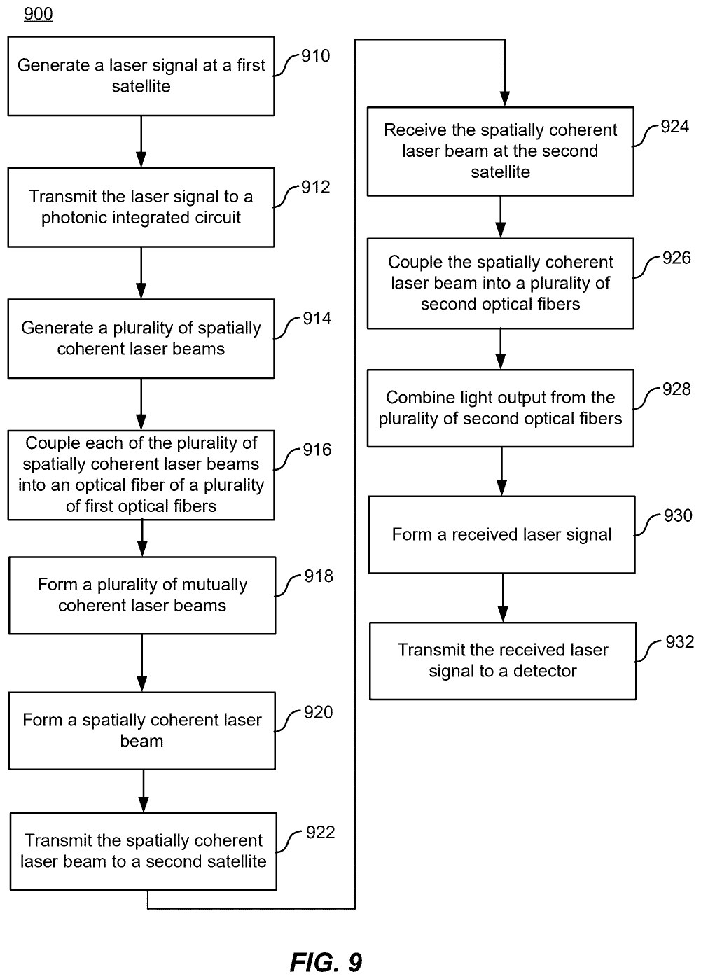

FIG. 9 is a simplified flowchart illustrating a method of performing inter-satellite communications according to an embodiment of the present invention. The method 900 includes generating a laser signal at a first satellite (910) and transmitting the laser signal to a photonic integrated circuit (PIC) (912). In some embodiments, the laser signal is generated using a laser transmitter that is a single mode laser that is transmitted to the PIC using a single mode fiber.

The method also includes generating a plurality of spatially coherent laser beams (914), coupling each of the plurality of spatially coherent laser beams into an optical fiber of a plurality of first optical fibers (916), forming a plurality of mutually coherent laser beams (918), and forming a spatially coherent laser beam (920). Thus, the plurality of mutually coherent laser beams output by the PIC are input into the optical fibers making up the plurality of first optical fibers. Each of the optical fibers in the plurality of first optical fibers is bonded to a microlens in a microlens array. In some embodiments, the optical fibers are bonded to the microlens using a laser weld. Since the each of the microlenses in the microlens array collimates each of the mutually coherent laser beams propagating in each of the first optical fibers, a spatially coherent laser beam with an aperture defined by the lateral dimensions of the microlens array is produced that is suitable for inter-satellite communications. The method also includes transmitting the spatially coherent laser beam to a second satellite (922).

The method 900 additionally includes receiving the spatially coherent laser beam at the second satellite (924) and coupling the spatially coherent laser beam into a plurality of second optical fibers (926). As illustrated herein, the spatially coherent laser beam can be received at a microlens array of a second laser communications terminal of the second satellite, which can be identical to the first laser communications terminal of the first satellite, and coupled into the plurality of second optical fibers disposed in an array configuration. The light output by each optical fiber of the plurality of second optical fibers is transmitted to a PIC, which is used to combine the light output from the plurality of second optical fibers (928) and form a received laser signal (930). The received laser signal is transmitted to a detector (932) in order to complete the inter-satellite communications process.

It should be noted that although FIG. 9 illustrates a method of transmitting data from a first satellite to a second satellite, the same system utilized to perform the method can also be utilized to transmit data from the second satellite back to the first satellite in order to implement bidirectional communications. One of ordinary skill in the art would recognize many variations, modifications, and alternatives.

It should be appreciated that the specific steps illustrated in FIG. 9 provide a particular method of performing inter-satellite communications according to an embodiment of the present invention. Other sequences of steps may also be performed according to alternative embodiments. For example, alternative embodiments of the present invention may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize many variations, modifications, and alternatives.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a laser communications terminal comprising: a laser; a receiver; a photonic integrated circuit (PIC) optically coupled to the laser and the receiver; a plurality of optical fibers, each of the plurality of optical fibers being optically coupled to the PIC; and a microlens array, wherein each of the plurality of optical fibers is attached to the microlens array.

Example 2 is the laser communications terminal of example 1 wherein the laser comprises a single mode laser.

Example 3 is the laser communications terminal of example(s) 1-2 wherein the microlens array includes a plurality of microlens elements and each of the plurality of optical fibers is attached to one of the plurality of microlens elements.

Example 4 is the laser communications terminal of example(s) 1-3 further comprising a fill-factor correction plate.

Example 5 is the laser communications terminal of example(s) 1-4 wherein the fill-factor correction plate is positioned adjacent to the microlens array.

Example 6 is the laser communications terminal of example(s) 1-5 wherein each of the plurality of optical fibers is attached to the microlens array at a microlens interface.

Example 7 is the laser communications terminal of example(s) 1-6 wherein the microlens interface is free of epoxy.

Example 8 is the laser communications terminal of example(s) 1-7 wherein: the PIC comprises a plurality of waveguides and a plurality of phase adjustment elements; and each of the plurality of waveguides is optically coupled to a corresponding phase adjustment element of the plurality of phase adjustment elements.

Example 9 is the laser communications terminal of example(s) 1-8 wherein the each of the plurality of optical fibers is attached to the microlens array using a laser weld.

Example 10 is the laser communications terminal of example(s) 1-9 wherein: the microlens array comprises a central region and a peripheral region surrounding the central region; and one or more optical fibers are joined to corresponding microlens elements in the peripheral region at positions farther from the center of the microlens array than corresponding positions of the corresponding microlens elements.

Example 11 is a method of performing inter-satellite communications, the method comprising: generating a laser signal at a first satellite; transmitting the laser signal to a photonic integrated circuit (PIC); generating a plurality of spatially coherent laser beams; coupling each of the plurality of spatially coherent laser beams into an optical fiber of a plurality of first optical fibers; forming a plurality of mutually coherent laser beams; forming a spatially coherent laser beam using the plurality of mutually coherent laser beams; transmitting the spatially coherent laser beam to a second satellite; receiving the spatially coherent laser beam at the second satellite; coupling the spatially coherent laser beam into a plurality of second optical fibers;

combining light output from the plurality of second optical fibers; forming a received laser signal; and transmitting the received laser signal to a detector.

Example 12 is the method of example 11 wherein each of the plurality of mutually coherent laser beams are collimated.

Example 13 is the method of example(s) 11-12 wherein forming a plurality of mutually coherent laser beams comprises: dividing the laser signal into a plurality of input signals; applying a phase adjustment to each of the plurality of input signals to produce a plurality of phase-adjusted input signals; and coupling each of the plurality of phase-adjusted input signals into one of the first optical fibers of the plurality of first optical fibers.

Example 14 is the method of example(s) 11-13 wherein forming a spatially coherent laser beam comprises collimating each of the plurality of spatially coherent laser beams using a microlens of a microlens array.

Example 15 is the method of example(s) 11-14 wherein the laser signal comprises a single mode laser beam.

Example 16 is the method of example(s) 11-15 wherein each of the plurality of first optical fibers comprises a single mode optical fiber.

Example 17 is the method of example(s) 11-16 wherein receiving the spatially coherent laser beam comprises coupling the spatially coherent laser beam into a microlens array at the second satellite.

Example 18 is the method of example(s) 11-17 wherein combining light output from the plurality of second optical fibers comprises using optical combiners in a second PIC at the second satellite.

Example 19 is the method of example(s) 11-18 wherein forming the received laser signal comprises removing intersymbol interference using phase adjustment elements at the second satellite.

Example 20 is the method of example(s) 11-19 wherein forming the received laser signal comprises removing optical impairments using phase adjustment elements at the second satellite.

Example 21 is the method of example(s) 11-20 further comprising: operating a plurality of phase adjustment elements in the PIC; and steering the spatially coherent laser beam.

Example 22 is the method of example(s) 11-21 further comprising: operating a plurality of phase adjustment elements in the PIC; and modifying a shape of the spatially coherent laser beam.

The technology described and claimed herein is not to be limited in scope by the specific preferred embodiments herein disclosed, since these embodiments are intended as illustrations, and not limitations, of several aspects of the technology. Any equivalent embodiments are intended to be within the scope of this technology. Indeed, various modifications of the technology in addition to those shown and described herein will become apparent to those skilled in the art from the foregoing description. Such modifications are also intended to fall within the scope of the appended claims.

What is claimed is:

1. A laser communications terminal comprising:
a laser;
a receiver;
a photonic integrated circuit (PIC) optically coupled to the laser and the receiver;
a plurality of optical fibers, each of the plurality of optical fibers being optically coupled to the PIC; and
a microlens array, wherein each of the plurality of optical fibers is attached to the microlens array.

2. The laser communications terminal of claim 1 wherein the laser comprises a single mode laser.

3. The laser communications terminal of claim 1 wherein the microlens array includes a plurality of microlens elements and each of the plurality of optical fibers is attached to one of the plurality of microlens elements.

4. The laser communications terminal of claim 1 further comprising a fill-factor correction plate.

5. The laser communications terminal of claim 4 wherein the fill-factor correction plate is positioned adjacent to the microlens array.

6. The laser communications terminal of claim 1 wherein each of the plurality of optical fibers is attached to the microlens array at a microlens interface.

7. The laser communications terminal of claim 6 wherein the microlens interface is free of epoxy.

8. The laser communications terminal of claim 1 wherein:
the PIC comprises a plurality of waveguides and a plurality of phase adjustment elements; and
each of the plurality of waveguides is optically coupled to a corresponding phase adjustment element of the plurality of phase adjustment elements.

9. The laser communications terminal of claim 1 wherein the each of the plurality of optical fibers is attached to the microlens array using a laser weld.

10. The laser communications terminal of claim 1 wherein:
the microlens array comprises a central region and a peripheral region surrounding the central region; and
one or more optical fibers are joined to corresponding microlens elements in the peripheral region at positions farther from the center of the microlens array than corresponding positions of the corresponding microlens elements.

11. A method of performing inter-satellite communications, the method comprising:
generating a laser signal at a first satellite;
transmitting the laser signal to a photonic integrated circuit (PIC);
generating a plurality of spatially coherent laser beams;
coupling each of the plurality of spatially coherent laser beams into an optical fiber of a plurality of first optical fibers;
forming a plurality of mutually coherent laser beams;
forming a spatially coherent laser beam using the plurality of mutually coherent laser beams;
transmitting the spatially coherent laser beam to a second satellite;
receiving the spatially coherent laser beam at the second satellite;
coupling the spatially coherent laser beam into a plurality of second optical fibers;
combining light output from the plurality of second optical fibers;
forming a received laser signal; and
transmitting the received laser signal to a detector.

12. The method of claim 11 wherein each of the plurality of mutually coherent laser beams are collimated.

13. The method of claim 11 wherein forming a plurality of mutually coherent laser beams comprises:
dividing the laser signal into a plurality of input signals;
applying a phase adjustment to each of the plurality of input signals to produce a plurality of phase-adjusted input signals; and
coupling each of the plurality of phase-adjusted input signals into one of the first optical fibers of the plurality of first optical fibers.

14. The method of claim 11 wherein forming a spatially coherent laser beam comprises collimating each of the plurality of spatially coherent laser beams using a microlens of a microlens array.

15. The method of claim 11 wherein receiving the spatially coherent laser beam comprises coupling the spatially coherent laser beam into a microlens array at the second satellite.

16. The method of claim 11 wherein combining light output from the plurality of second optical fibers comprises using optical combiners in a second PIC at the second satellite.

17. The method of claim 11 wherein forming the received laser signal comprises removing intersymbol interference using phase adjustment elements at the second satellite.

18. The method of claim 11 wherein forming the received laser signal comprises removing optical impairments using phase adjustment elements at the second satellite.

19. The method of claim 11 further comprising:
operating a plurality of phase adjustment elements in the PIC; and
steering the spatially coherent laser beam.

20. The method of claim 19 further comprising:
operating a plurality of phase adjustment elements in the PIC; and
modifying a shape of the spatially coherent laser beam.
